(19) United States
(12) Patent Application Publication
(10) Pub. No.: US 2017/0167674 A1
(43) Pub. Date: Jun. 15, 2017

(54) Nightlight Display

(71) Applicant: Darrell Frycz, Northfield, OH (US)

(72) Inventor: Darrell Frycz, Northfield, OH (US)

(21) Appl. No.: 15/183,956

(22) Filed: Jun. 16, 2016

Related U.S. Application Data
(60) Provisional application No. 62/267,571, filed on Dec. 15, 2015.

(51) Int. Cl. F21S 8/00; F21V 23/00; F21V 17/00; F21V 23/04

(52) U.S. Cl. CPC F21S 8/035; F21V 23/04; F21V 23/003; F21V 17/002; F21Y 2101/02

(57) ABSTRACT

A nightlight display is provided that can be used to illuminate an area and project an illuminated display therefrom. The nightlight has a nightlight base that connects to a power source and an upwardly projecting light source. Coupled to the nightlight base is a translucent plate with indicia thereon. The light source and plate are aligned so the plate is edge-lit and the light source projects through the plate. When energized, the light source illuminates the indicia thereon, wherein the indicia reflect the light in a preferably diffuse manner to project a desired display from the plate. The light source is preferably an LED and the plate is preferably an etched acrylic plate. The plate and nightlight base may also be removable from one another to replace the plate with a different display.

### CROSS REFERENCE TO RELATED APPLICATION

This application claims the benefit of U.S. Provisional Application No. 62/267,571 filed on Dec. 15, 2015. The above identified patent application is herein incorporated by reference in its entirety to provide continuity of disclosure.

### BACKGROUND OF THE INVENTION

### Field of the Invention

The present invention relates to nightlights and illuminated displays. More specifically, the present invention relates to a new nightlight assembly having a translucent plate and a nightlight base, whereby a light source illuminates an edge of the translucent plate and indicia along the plate reflects the light to illuminate a specific pattern, symbol, or message thereon.

Nightlights are often utilized to provide a small amount of light in a dark area to facilitate navigation in the dark or to provide a degree of ambient light in an otherwise dark room. The present invention provides a nightlight that is personalized and projects a desired message when illuminated. The nightlight of the present invention utilizes a preferably acrylic plate having indicia thereon, whereby the plate is edge-lit by a light source along the base of the nightlight. The light reflects from of the indicia portions of the plate to illuminate the indicia pattern, projecting a desired display and sending light into the surrounding area.

More specifically, the nightlight of the present invention includes a nightlight base and a translucent plate connected thereto. The nightlight base is connectable to an electrical outlet. The nightlight base is connected to a translucent plate having indicia thereon in a defined pattern. The plate is preferably an acrylic material and the indicia pattern is preferably etched thereon; however the material of the plate and the process by which the indicia is created on the plate may vary. The plate is edge-lit by preferably an LED light source along the nightlight base, whereby the indicia pattern is clearly illuminated and visible when the light source is energized. The plate preferably has a lower surface with a socket and a recession within the socket, whereby the socket receives a shoulder portion along the top of the nightlight base to couple the plate to the nightlight base. When the nightlight is illuminated, the indicia pattern reflects light from the light source in a diffuse pattern to provide an illuminated area around the nightlight and to display a desired pattern along the plate.

### SUMMARY OF THE INVENTION

The following summary is intended solely for the benefit of the reader and is not intended to be limiting in any way. The present invention provides a new nightlight display wherein the same can be utilized for providing convenience for the user when illuminating an area and providing a desired illuminated display.

It is therefore an object of the present invention to provide a new and improved nightlight display that has all of the advantages of the prior art and none of the disadvantages.

It is another object of the present invention to provide a nightlight display that comprises a nightlight base and a translucent plate coupled thereto.

Another object of the present invention is to provide a nightlight display wherein the nightlight base forms an enclosure having an upper surface, a rear surface, and a front surface. Electrical outlet prongs extend from the rear surface of the nightlight base and are adapted to couple to an electrical outlet.

Another object of the present invention is to provide a nightlight display wherein the nightlight base further comprises a light source directed upwards from the upper surface thereof.

Another object of the present invention is to provide a nightlight display wherein the translucent plate is connected to the nightlight base and extends upwards from the upper surface thereof. The translucent plate comprises a substantially planar surface with a lower edge aligned with the light source of the nightlight base.

Another object of the present invention is to provide a nightlight display wherein the translucent plate further comprises indicia thereon, the indicia being adapted to reflect light from the light source when the light source is energized.

Another object of the present invention is to provide a nightlight display wherein the translucent plate in one embodiment further comprises a thermoplastic material.

Another object of the present invention is to provide a nightlight display wherein the translucent plate in another embodiment further comprises an acrylic material.

Another object of the present invention is to provide a nightlight display wherein the translucent plate further comprises a transparent material.

Another object of the present invention is to provide a nightlight display wherein the translucent plate is removably attached to the nightlight base.

Another object of the present invention is to provide a nightlight display wherein the upper surface of the nightlight base further comprises a raised portion forming an elevated surface and a shoulder between the elevated surface and the upper surface of the nightlight base. The translucent plate further comprises a socket along its lower edge that is adapted to receive the raised portion of the nightlight base therein when the plate is coupled to the nightlight base.

Another object of the present invention is to provide a nightlight display wherein the light source projects light through a transparent window along the upper surface or raised portion of the nightlight base.

Another object of the present invention is to provide a nightlight display wherein the transparent window may comprise a colored surface that changes the color of the light projected from the nightlight base.

Another object of the present invention is to provide a nightlight display wherein the light source may comprise a light emitting diode.

Another object of the present invention is to provide a nightlight display wherein the nightlight base further comprises an electrical circuit within the enclosure. The electrical circuit preferably comprises a light emitting diode, one or more transistors, and one or more resistor. The electrical circuit receives electrical power from the electrical outlet prongs when connected to an electrical outlet.

Another object of the present invention is to provide a nightlight display wherein the circuit may further comprise a switch to control the flow for current to the electrical outlet from the electrical outlet.

Another object of the present invention is to provide a nightlight display wherein the circuit may further comprise a light-dependent resistor to control the flow for current to the electrical outlet from the electrical outlet based on ambient light around the nightlight base.

Another object of the present invention is to provide a nightlight display wherein the indicia may further comprise etched indicia.

Another object of the present invention is to provide a nightlight display wherein the etched indicia is formed along the translucent plate using a laser etching process.

Another object of the present invention is to provide a nightlight display wherein the indicia may further comprise engraved indicia.

Another object of the present invention is to provide a nightlight display wherein the indicia may further comprise printed indicia.

Another object of the present invention is to provide a nightlight display wherein the indicia may further comprise silkscreened indicia.

Another object of the present invention is to provide a nightlight display wherein the indicia is further adapted to reflect light from the light source in a diffuse pattern when the light source is energized.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal perspective view of the nightlight display of the present invention.

FIG. 2 provides a view of the nightlight base of the present invention.

FIG. 3 provides an embodiment of the translucent plate of the present invention.

FIG. 4 provides an embodiment of the electrical circuit within the enclosure.

FIG. 5 provides a view of an embodiment of the nightlight base.

### DETAILED DESCRIPTION OF THE INVENTION

Reference is made herein to the attached drawings. Like reference numerals are used throughout the drawings to depict like or similar elements of the nightlight base of the present invention. For the purposes of presenting a brief and clear description of the present invention, the preferred embodiment will be discussed as used for illuminating an area and projecting an illuminated display. The figures are intended for representative purposes only and should not be considered to be limiting in any respect.

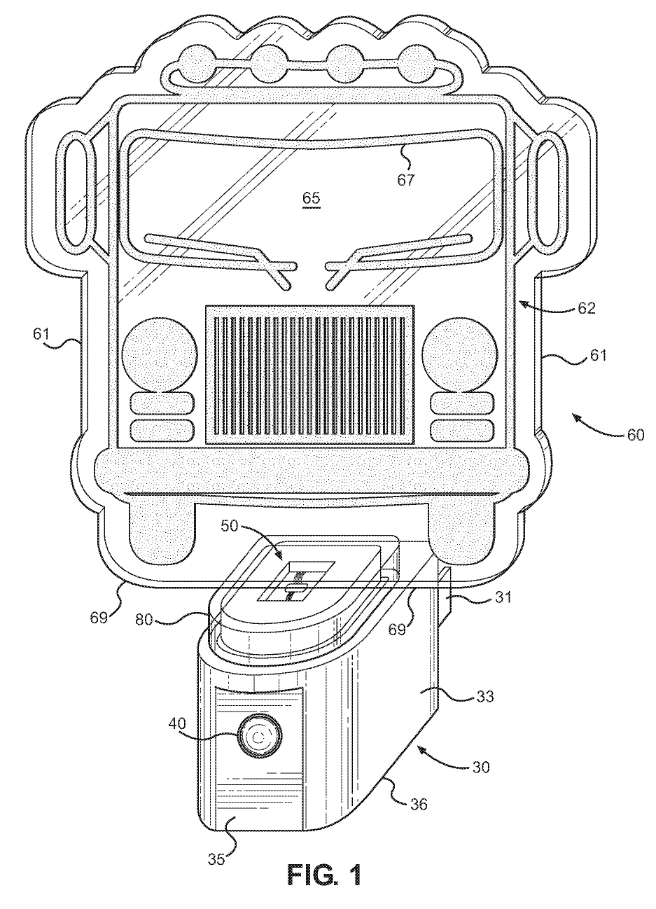

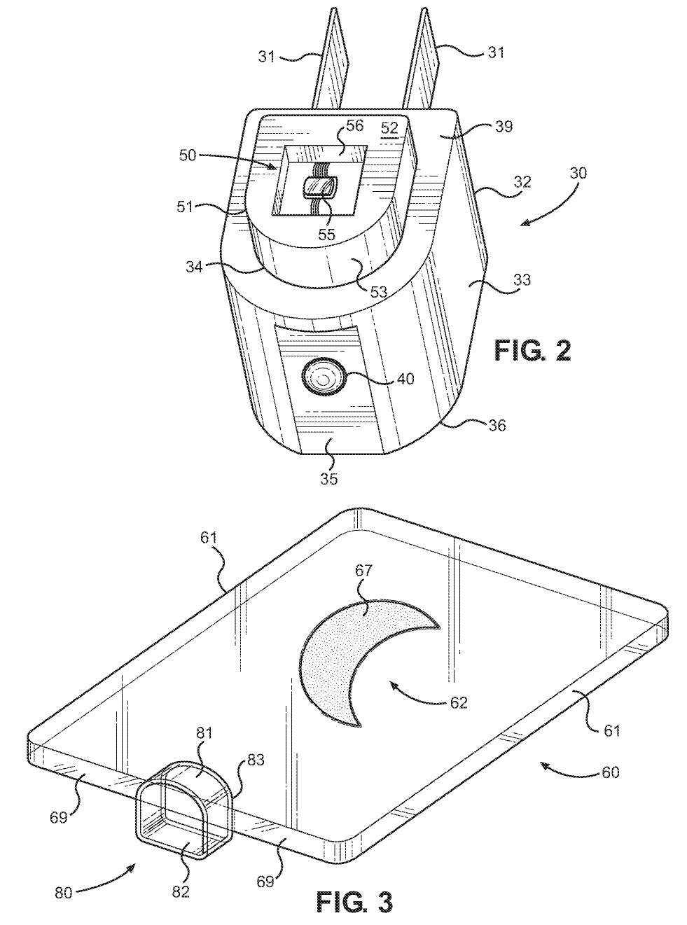

The present invention is a nightlight that provides illumination and a desired display when energized. Referring to FIGS. 1 and 2, there are shown views of the nightlight display assembly as a whole and a detailed view of the nightlight base 30, respectively. The nightlight display is an assembly comprising a nightlight base 30 and a translucent plate 60 connected thereto. The nightlight base 30 forms an enclosure having an upper surface 39 and sidewalls. The sidewalls preferably include a lower surface 36, a rear surface 32, and a front surface 35. The translucent plate 60 is coupled to the nightlight base 30 and extends upwardly therefrom. The translucent plate 60 preferably comprises a substantially planar surface 65 with a lower edge 69 aligned with a light source 50 disposed on the nightlight base 30.

The light source 50 of the nightlight base 30 is an upwardly-projecting light that preferably comprises a light emitting diode (LED) 55. The light source 50 projects upwardly and is disposed along the upper surface 39 of the nightlight base 30. More specifically, the light source 50 may project through a transparent window 56 along the nightlight base 30, the window 56 being disposed along the upper surface 39 thereof or along the upper surface of a raised portion 51 therealong. In the latter case, the upper surface 39 of the nightlight base 30 comprises a raised portion 51 forming an elevated surface 52 and a shoulder 34 between the elevated surface 52 and the upper surface 39 of the nightlight base 30. The raised portion 51 includes upwardly extending sidewalls 53 and a defined cross section that is adapted to be received within a socket 80 along the lower edge 69 of the translucent plate 60. Therefore the raised portion 51 is received within the socket 80 to couple the plate 60 to the nightlight base 30. The socket 80 includes a recess or aperture therein that accepts the raised portion 51 therethrough. The plate 60 and socket 80 may be coupled together by way of a friction fit joint, or alternatively transparent adhesive may also be applied at the joint to ensure a secure connection therebetween.

Along the rear surface 32 of the nightlight base 30 are electrical outlet prongs 31 extending therefrom, which are adapted to couple to an electrical outlet and provide electrical power to the light source 50. Controlling the light source 50 may furthermore be a physical switch provided along a sidewall of the base 30, or alternatively a light sensor 40 may be provided. The light sensor 40 measures ambient light and switches the light source 50 on and off without user interaction. In a preferred embodiment, the light sensor 40 comprises a light-dependent resistor and the sensor 40 is disposed along the front surface 35 of the base 30, opposite of the electrical prongs 31. The flow of electrical current from the electrical prongs 31 and to the light source 50 is controlled by an electric circuit within the nightlight base 30.

Referring now to FIGS. 1 and 3, there are shown exemplary embodiments of the translucent plate 60. The translucent plate 60 comprises a substantially planar surface 65 with a lower edge 69 aligned with the light source 50 of the nightlight base 30. The plate 60 preferably comprises outer edges 61 and a substantially two-dimensional shape; however, three dimensional embodiments are contemplated in which the plate has a varying thickness. The preferred planar shape allows the light source 50 to project light through the edge 69 of the plate, whereby indicia 62 along the plate 60 reflects the light to highlight the indicia pattern 67 thereon. The indicia 62 reflects the light in a preferably diffuse pattern, however specular reflection of the light from the indicia 62 is also contemplated.

The material of the translucent plate 60 is preferably a thermoplastic material, such as acrylic glass or the like. Acrylic glass is a transparent thermoplastic material that can act as a background for the indicia pattern 67, which reflects the incoming light from the light source 50 while the plate 60 serves as a clear or colored background therearound. Therefore, the plate 60 may comprise a translucent or transparent plate, while the indicia 62 thereon is substantially opaque thereon and disposed in a manner to reflect incoming light as the light travels through the plate thickness from its lower edge 69.

The indicia 62 on the plate 60 may be created in several different manners. In a preferred embodiment, the indicia pattern 67 is etched along the surface of the plate 60. The indicia pattern 67 is formed through a laser etching or alternative etching process, thereby creating a pattern 67 on the plate 60 that reflects the edge light. Alternatively, the indicia pattern 67 further comprises engraved indicia, printed indicia, or silkscreened indicia on the plate surface. Engraved indicia are created through a cutting process in which material from the surface of the plate is removed or roughened to create the desired pattern. When light reaches the engraved portions, the light scatters or is otherwise reflected through the rough surface thereof. Likewise, printed or silkscreened indicia patterns 67 are paint or material deposited onto the surface of the plate 60, wherein the material reflects the edge light when the light is energized. Since the plate is translucent or transparent, the display pattern will be illuminated in dark light using any of these processes. Therefore, the nightlight projects light upward while illuminating a specific pattern defined by the indicia 62.

In some embodiments, the plate 60 is removable from the nightlight base to allow the user to change the display. As shown in FIG. 3, the plate 60 may comprise a socket 80 along its lower edge 69. The socket 80 includes a recess 82 defined within socket walls 81 and a socket upper surface 83. The raised portion 51 of the nightlight base is received within the recess 82 of the socket 80, connecting the two together. The connection may simply be a friction fit or press fit between the socket 80 and raised portion 51, or alternatively optical adhesive may be applied at this joint to maintain the connection.

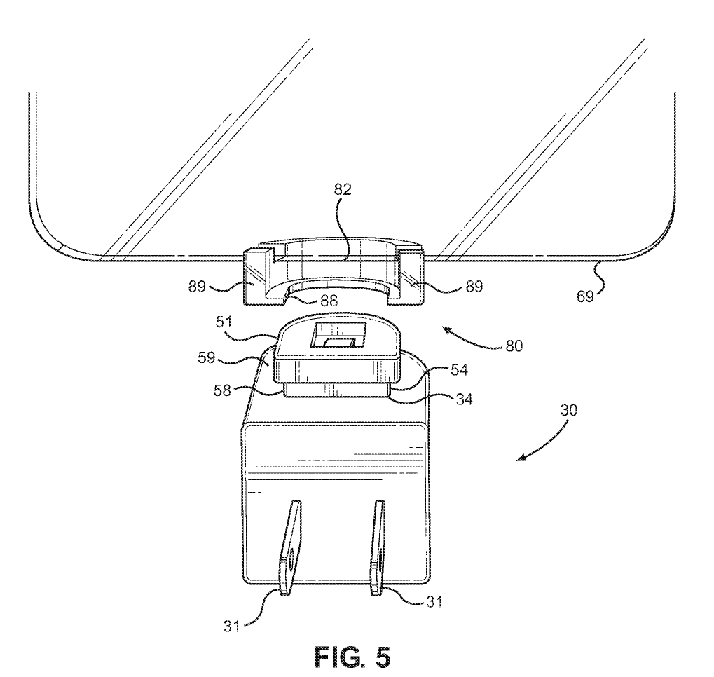

In addition, the plate 60 may be removably connected to the raised portion 51 via a sliding joint, as provided in FIG. 5. As shown, in this embodiment the sidewall of the raised portion 51 forms a channel 54 that is adapted to receive the lower edge 88 of the display socket 80. More specifically, the raised portion 51 of the housing 30 has a groove or channel 54 that extends inward from its sidewalls. The display socket 80 also has a lower edge 88 that extends inward from the sidewalls 89 of the socket 80. This lower edge 88 forms a perimeter that is adapted to be received and abutted against the inner surface 58 of the channel 54, whereby socket 80 slidably engages the channel 54 of the raised portion 51 to secure the same. One end of the socket 80 is open, and the upper end of the raised portion 51 is received within the recess 82 of the socket 80 when the two are slidably engaged. This prevents the display from be separated from the housing via upward tension. Rather, the lower edge 88 engages the channel 54 in friction/press fit, and are removable when pressed apart in a lateral direction (i.e. towards the closed end of the display socket 80).

Referring now to FIG. 2, there is shown a view of an embodiment of the light source 50, whereby the light 55 is disposed below a transparent window 56. In this embodiment, the transparent window 56 is positioned over the light 55 and may comprise a colored surface that changes the color of the light projected from the nightlight base 30 and into the plate. This embodiment may be used to project a display of certain color. Alternatively, the transparent window 56 may be clear and the light 55 itself may be a colored LED. In either embodiment, the plate and the indicia thereon will project the color of the window or LED color.

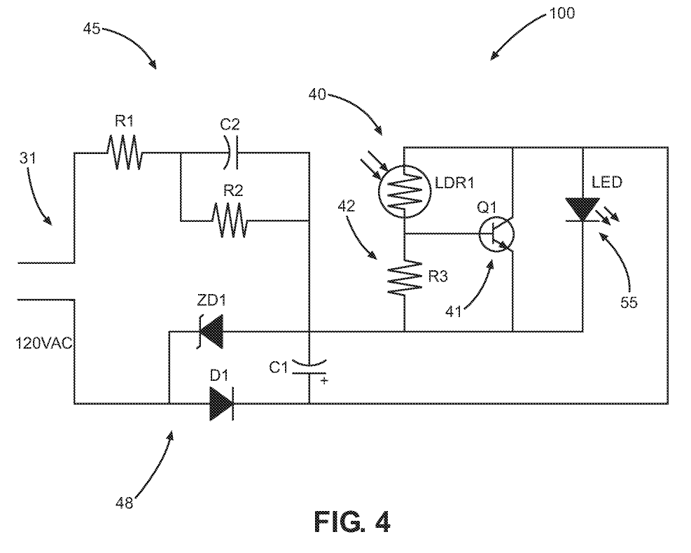

Referring now to FIG. 4, there is shown an embodiment of the electrical circuit 100 within the nightlight base. The electrical circuit 100 comprises a light emitting diode 55 and supporting electrical components to emit light from the nightlight base and control the flow of current from the electrical prongs 31 and flowing through the circuit 100. In the embodiment shown, the LED circuit includes an LED 55, one or more transistors 41, a resister R3 42, and a light-dependent resistor 40. The light-dependent resistor 40 and transistor 41 control the flow of current to the LED 55, whereby low ambient light triggers the circuit to activate the LED 55. Alternatively, a physical switch may be provided for the user to manually activate the LED. In addition, the electrical circuit 100 comprises an R1-R2-C2 circuit 45 and a ZD1-ZD1-C1 circuit 48. The R1-R2-C2 circuit functions by providing an AC impedance that limits the AC current in the circuit. The ZD1-ZD1-C1 circuit functions as a half wave rectifier to produce a constant DC voltage to power the LED 55. This specific electrical circuit 100 is one embodiment contemplated by the present invention.

Overall, the present invention provides a new nightlight device with a nightlight base and a nightlight display. The display is formed by the upwardly projecting light source and the edge-lit plate, which includes indicia thereon that reflects light in the pattern of the indicia. This provides ambient light and displays a specific symbol, display, message, or other pattern from the plate. The size of the plate and the shape of the plate perimeter may vary in order to provide user customization. In addition, the indicia thereon may form a specific display, as desired by the user.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A nightlight display, comprising:
a nightlight base forming an enclosure and having an upper surface, a rear surface, and a front surface;
electrical outlet prongs extending from the rear surface of the nightlight base that are adapted to couple to an electrical outlet;
a light source directed upwards from the upper surface of the nightlight base;
a translucent plate connected to the nightlight base and extending upwards from the upper surface thereof;
the translucent plate comprising a substantially planar surface with a lower edge aligned with the light source of the nightlight base;
the translucent plate further comprising indicia thereon, the indicia being adapted to reflect light from the light source when the light source is energized.

2) The nightlight display of claim 1, wherein the translucent plate further comprises a thermoplastic material.

3) The nightlight display of claim 1, wherein the translucent plate further comprises a transparent material.

4) The nightlight display of claim 1, wherein the translucent plate further comprises an acrylic material.

5) The nightlight display of claim 1, wherein the translucent plate is removably attached to the nightlight base.

6) The nightlight display of claim 1, wherein:
the upper surface of the nightlight base further comprises a raised portion forming an elevated surface and a shoulder between the elevated surface and the upper surface of the nightlight base;
the translucent plate further comprising a socket along its lower edge that is adapted to receive the raised portion of the nightlight base therein.

7) The nightlight display of claim 1, wherein the light source projects light through a transparent window along the nightlight base.

8) The nightlight display of claim 1, wherein the transparent window is a colored surface that changes the color of the light projected from the nightlight base.

9) The nightlight display of claim 1, wherein the light source is a light emitting diode.

10) The nightlight display of claim 1, wherein:
the nightlight base further comprises an electrical circuit within its enclosure;
the electrical circuit comprises a light emitting diode, one or more transistors, and one or more resistor;
wherein the electrical circuit receives electrical power from the electrical outlet prongs when connected to an electrical outlet.

11) The nightlight display of claim 10, further comprising a switch to control the flow for current to the electrical outlet from the electrical outlet.

12) The nightlight display of claim 10, further comprising a light-dependent resistor to control the flow for current to the electrical outlet from the electrical outlet based on ambient light around the nightlight base.

13) The nightlight display of claim 1, wherein the indicia further comprises etched indicia.

14) The nightlight display of claim 13, wherein the etched indicia is formed along the translucent plate by a laser etching process.

15) The nightlight display of claim 1, wherein the indicia further comprises engraved indicia.

16) The nightlight display of claim 1, wherein the indicia further comprises printed indicia.

17) The nightlight display of claim 1, wherein the indicia further comprises silkscreened indicia.

18) The nightlight display of claim 1, wherein the indicia is further adapted to reflect light from the light source in a diffuse pattern when the light source is energized.
